(19) United States
(12) Patent Application Publication
(10) Pub. No.: US 2020/0187285 A1
(43) Pub. Date: Jun. 11, 2020

(54) COMBINING FREQUENCY BANDS FOR WIRELESS COMMUNICATIONS

(71) Applicant: ZTE Wistron Telecom AB, Stockholm (SE)

(72) Inventor: Aijun Cao, Stockholm (SE)

(21) Appl. No.: 16/708,078

(22) Filed: Dec. 9, 2019

Related U.S. Application Data
(60) Provisional application No. 62/777,197, filed on Dec. 9, 2018.

(51) Int. Cl. H04W 76/15; H04W 72/04; H04L 5/00; H04B 17/309; H04W 72/08; H04W 52/54

(52) U.S. Cl. CPC H04W 76/15; H04W 72/042; H04W 72/0453; H04W 72/0413; H04W 52/54; H04L 5/0053; H04B 17/309; H04W 72/085; H04L 5/0098; H04L 5/0048

(57) ABSTRACT

Method, systems and devices for combining uplink and downlink channels in different frequency bands for wireless communication, are described. In a representative aspect, a method for wireless communication includes establishing, by a network node, a first cell comprising a first channel on which the network node receives communications and a second channel on which the network node transmits communications, and performing a bi-directional communication with a wireless device using the first cell, wherein the first channel comprises a first frequency from a first frequency band and the second channel comprises a second frequency from a second frequency band different from the first frequency band, the first frequency is designated for communications from the wireless device to the network node, and the second frequency is designated for communication from the network node to the wireless device.

### CROSS-REFERENCE TO RELATED APPLICATION

This patent document claims priority to and benefits of U.S. Provisional Patent Application No. 62/777,197 entitled “COMBINING FREQUENCY BANDS FOR WIRELESS COMMUNICATIONS” and filed on Dec. 9, 2018. The aforementioned patent application is incorporated by reference, in its entirety, as part of the disclosure of this patent document.

### TECHNICAL FIELD

This patent document relates to wireless communications, and more particularly, to resource management is cellular communication systems.

### BACKGROUND

Next generation of wireless technologies are expected to enable more wireless connectivity and applications, including bandwidths that are far greater than currently available bandwidths in wireless networks.

### SUMMARY

This document relates to methods, systems and devices for combining frequency bands for wireless communication, e.g., cellular communication systems.

In one example aspect, a wireless communication method is disclosed. The method includes establishing, by a network node, a first cell comprising a first channel on which the network node receives communications and a second channel on which the network node transmits communications, and performing a bi-directional communication with a wireless device using the first cell, wherein the first channel comprises a first frequency from a first frequency band and the second channel comprises a second frequency from a second frequency band different from the first frequency band, wherein the first frequency is designated for communications from the wireless device to the network node, and wherein the second frequency is designated for communication from the network node to the wireless device.

In another example aspect, a wireless communication method is disclosed. The method includes performing, at a wireless device, a bi-directional communication with a network node using a cell comprising a first channel on which the wireless device transmits communications and a second channel on which the wireless device receives communications, wherein the first channel comprises a first frequency from a first frequency band and the second channel comprises a second frequency from a second frequency band different from the first frequency band.

In yet another exemplary aspect, the above-described methods are embodied in the form of processor-executable code and stored in a computer-readable program medium.

In yet another exemplary embodiment, a device that is configured or operable to perform the above-described methods is disclosed.

The above and other aspects and their implementations are described in greater detail in the drawings, the descriptions, and the claims.

### BRIEF DESCRIPTION OF THE DRAWINGS

FIG. 1 shows an example of combining two different frequency bands.

FIGS. 2A and 2B show examples of LTE frequency bands and channel bandwidths.

FIGS. 3A and 3B show examples of combining two different frequency bands, in accordance with some embodiments of the presently disclosed technology.

FIG. 4 shows an example of a wireless communication method, in accordance with some embodiments of the presently disclosed technology.

FIG. 5 shows an example of another wireless communication method, in accordance with some embodiments of the presently disclosed technology.

FIG. 6 is a block diagram representation of a portion of an apparatus, in accordance with some embodiments of the presently disclosed technology.

### DETAILED DESCRIPTION

The present document refers to terminology used in Third Generation Partnership Project (3GPP) only for the sake of explanation, and the disclosed techniques are applicable to wireless protocols and system that are different from the 3GPP protocols such as 2G, 3G, 4G and 5G protocols.

Wireless communication technologies are moving the world toward an increasingly connected and networked society. The rapid growth of wireless communications and advances in technology has led to greater demand for capacity and connectivity. Other aspects, such as energy consumption, device cost, spectral efficiency, and latency are also important to meeting the needs of various communication scenarios. In comparison with the existing wireless networks, next generation systems and wireless communication techniques need to provide support for an increased number of users and devices, thereby requiring robust and efficient configuring of communication links including, for example, combining uplink and downlink channels from different frequency bands for wireless communication.

After several decades of evolution, e.g., from 2G, 3G and 4G, and now 5G, the current mobile communication networks are able to provide billions of mobile users with data transmission service via almost ubiquitous radio access at anywhere and anytime. Different generations of mobile networks have distinguished features, technologies, and even network architectures. Along with the never-ending increasing demand for higher data rates, higher spectrum with broader usable bandwidth are considered and included into the mobile communication networks.

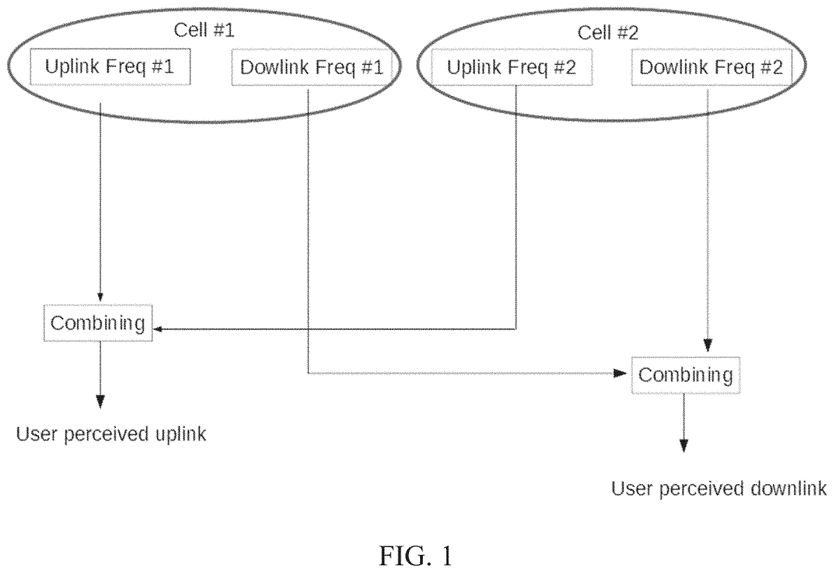

The protection of investment, for both operators and end users, is one of the main concerns when upgrading mobile networks to a newer generation. Therefore, there has been increased interest in how to make use of the existing spectrum owned by operators. Different techniques such as carrier aggregation (CA), dual connectivity (DC), etc., meet this demand and at the same time, increase the achievable data rate for end users. These techniques combine different frequency bands each of which can also operate as an independent cell, as shown in the example in FIG. 1.

Carrier aggregation combines the component carriers at the logical channel level, which means that one logical channel is formed from two different transport channels. The UE is now able to communicate at an increased throughput over multiple component carriers from a single base station (e.g., eNB).

Dual connectivity allows a UE to simultaneously transmit and receive data on multiple component carriers from two cell groups via a Master eNB (MeNB) and a secondary eNB (SeNB), which are connected via a backhaul. In the dual connectivity framework, the combining is done at radio bearer level.

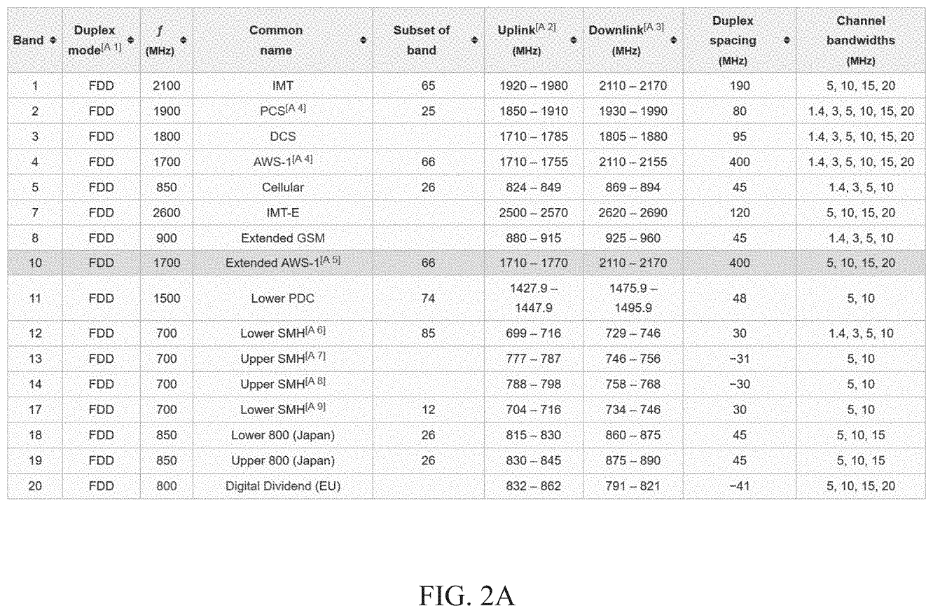

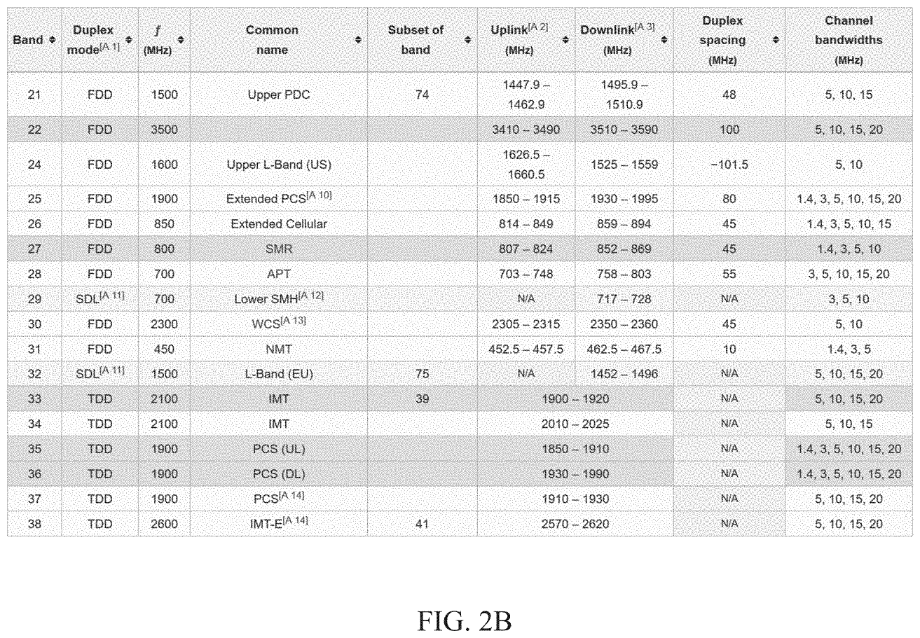

FIGS. 2A and 2B show example LTE frequency bands and channel bandwidths from Tables 5.5-1 “E-UTRA Operating Bands” and 5.6.1-1 “E-UTRA Channel Bandwidth” of 3GPP TS 36.101. As shown therein, traditional cellular communication is supported using different frequency bands, with each frequency band using different frequency ranges for the uplink and the downlink. Each of the uplink and downlink frequency ranges is divided into channels with different channel bandwidths. In an example, a single frequency band may be used to support both the uplink and downlink channels in a single cell, or for a particular user in that cell.

Current implementations combine uplink and downlink channels from different cells, each of which operates within a single frequency band by using either carrier aggregation (in which the combining is performed at the logical channel level) or dual connectivity (in which the combining is performed at a level higher than the logical channel level, e.g., core network level).

However, in some cases (e.g., if the uplink and downlink coverages are not matched, which may result to some UEs having only one uplink or only one downlink that is correctly received), then the framework shown in FIG. 1 actually lowers the spectrum efficiency if the signalling overhead and transmission failure rate are considered. Embodiments of the disclosed technology provide methods to increase the spectrum efficiency in these cases.

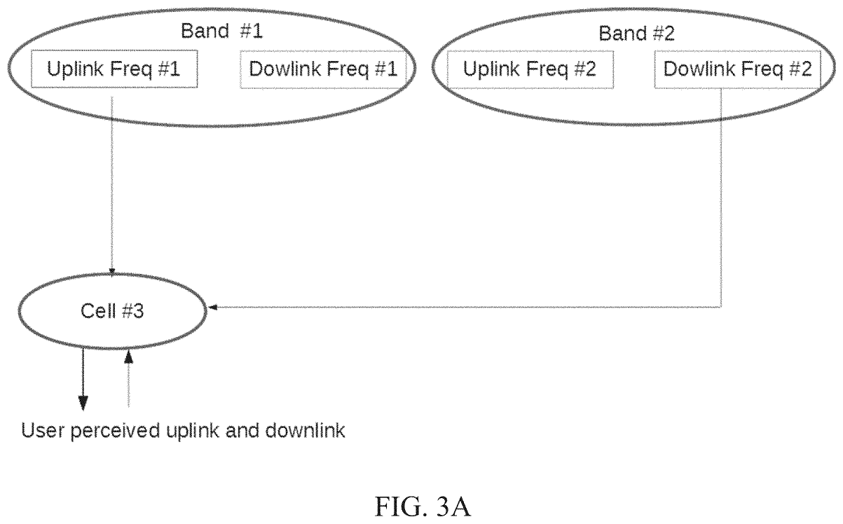

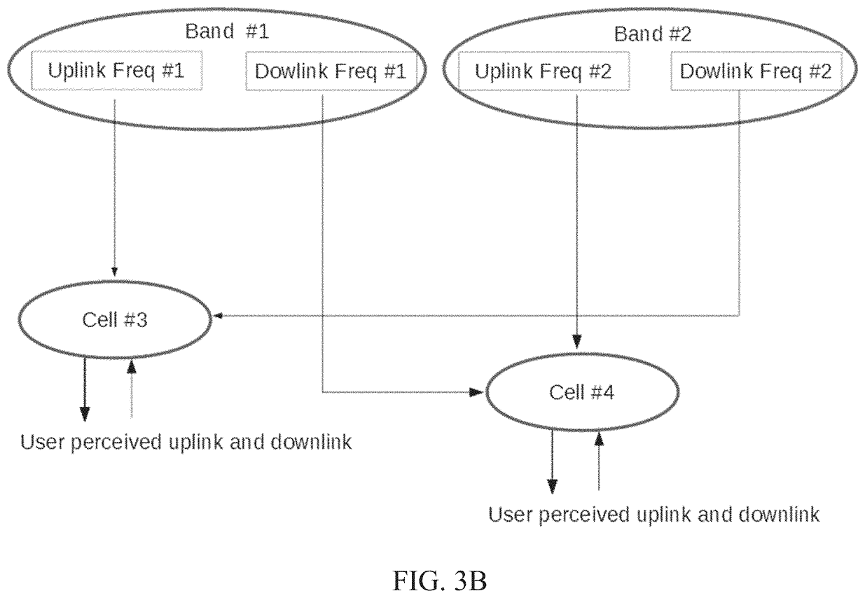

FIGS. 3A and 3B show examples of combining two different frequency bands, in accordance with some embodiments of the presently disclosed technology. As shown in FIG. 3A, a new cell (e.g., cell #3) may be created with uplink and downlink frequency from two different frequency bands. In the example shown in FIG. 3B, two new cells (e.g., cell #3 and cell #4) are each created with uplink and downlink frequencies from two different bands.

In some embodiments, band #1 or band #2 may only contain a downlink frequency, which is referred to as a supplementary downlink. Herein, the solitary downlink frequency and an uplink from another frequency band are used to create a cell.

In FIGS. 3A and 3B, the cells (e.g., cell #3 and cell #4) created by the network node (e.g., base station or eNB) provide the wireless device (or UE) with an uplink and a downlink for bi-directional communication such that the combination of the uplink and the downlink from two different frequency bands is transparent to the wireless device. The UE may operate with no explicit knowledge of the uplink and downlink channels being from different frequency bands.

In some embodiments, the uplink and downlink channels may have different pathloss exponents since they are from different frequency bands. For example, there may be more attenuation on either the uplink or the downlink. In these scenarios, the network node, which typically handles uplink power control, will signal an initial transmission power to the UE, thereby ensuring that UE operation remains seamless (and transparent) with respect to the spectrum efficiency gains that are achieved by combining different frequency bands.

In some embodiments, two or more cells may be created from different frequency bands (and are not limited to the embodiments illustrated in FIGS. 3A and 3B). In particular, any combination of uplink and downlink frequencies from different frequency bands supported by a cell may be implemented to create different “virtual” cells for the users in that cell.

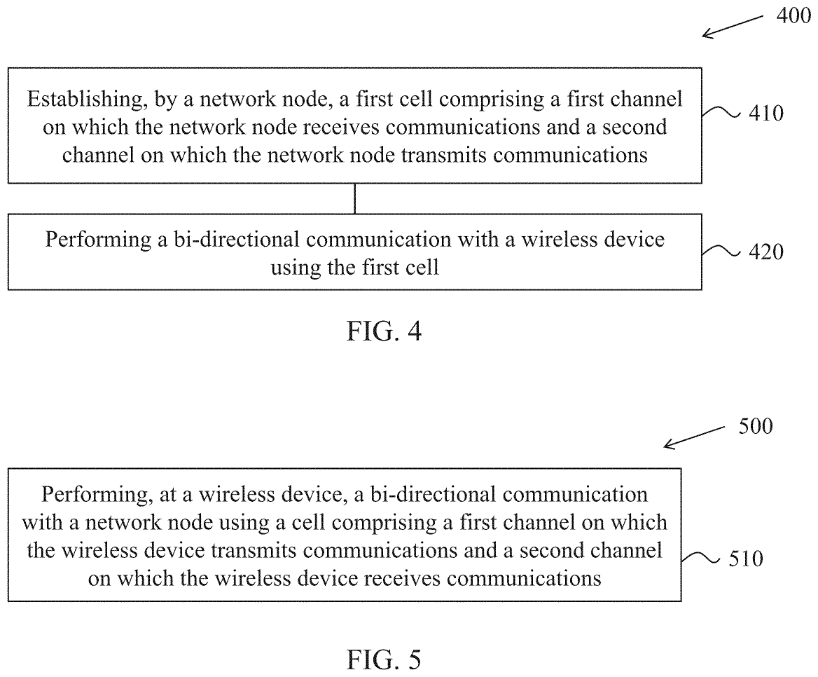

FIG. 4 shows a flowchart of an exemplary method 400 for combining frequency bands for wireless communication. The method 400 includes, at operation 410, establishing, by a network node, a first cell comprising a first channel on which the network node receives communications and a second channel on which the network node transmits communications.

The method 400 includes, at operation 420, performing a bi-directional communication with a wireless device using the first cell, where the first channel comprises a first frequency from a first frequency band and the second channel comprises a second frequency from a second frequency band different from the first frequency band, the first frequency is designated for communications from the wireless device to the network node, and the second frequency is designated for communication from the network node to the wireless device.

In some embodiments, the method 400 further includes the operations of establishing a second cell comprising a third channel on which the network node receives communications and a fourth channel on which the network node transmits communications, and performing another bi-directional communication with another wireless device using the second cell, where the third channel comprises a third frequency from the second frequency band, the fourth channel comprises a fourth frequency from the first frequency band, the third frequency is designated for communications from the wireless device to the network node, and the fourth frequency is designated for communication from the network node to the wireless device.

In some embodiments, the second channel is a supplementary channel, and the secondary frequency band excludes a frequency that is designated for communications from the wireless device to the network node.

In some embodiments, the method 400 further includes the operations of determining that a first pathloss for the first channel is different from a second pathloss for the second channel, and signaling, to the wireless device, power control information for the first channel based on the first pathloss and the second pathloss. In an example, the power control information for the first channel comprises an initial power for transmissions by the wireless device.

In some embodiments, the method 400 further includes the operation of selecting the first frequency band and the second frequency band based on a number or a geographic distribution of wireless devices in a cell.

In some embodiments, the method 400 further includes the operation of broadcasting, to at least the wireless device, information corresponding to the first and second frequencies.

FIG. 5 shows a flowchart of another exemplary method 500 for combining frequency bands for wireless communication. The method 500 includes, at operation 510, performing, at a wireless device, a bi-directional communication with a network node using a cell comprising a first channel on which the wireless device transmits communications and a second channel on which the wireless device receives communications, where the first channel comprises a first frequency from a first frequency band and the second channel comprises a second frequency from a second frequency band different from the first frequency band.

In some embodiments, the method 500 further includes the operation of receiving an initial transmit power parameter for the first channel, where a transmission of the bi-directional communication is performed using a power based on the initial transmit power parameter for the first channel.

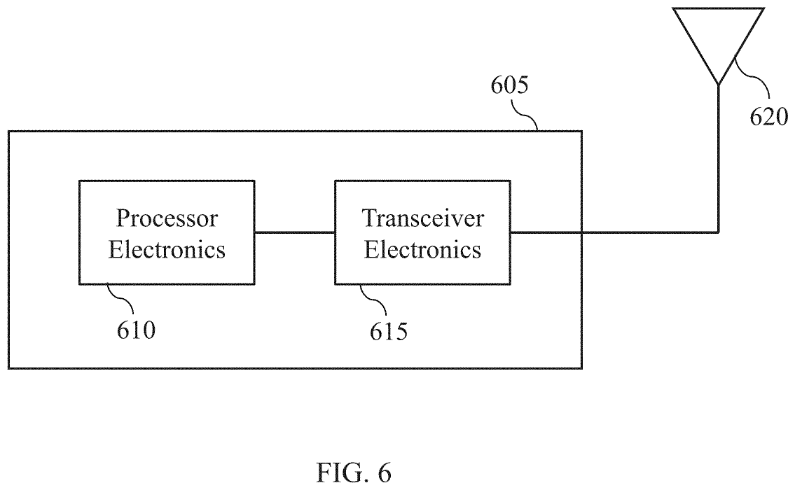

FIG. 6 is a block diagram representation of a portion of an apparatus, in accordance with some embodiments of the presently disclosed technology. An apparatus 605, such as a base station or a wireless device (or UE), can include processor electronics 610 such as a microprocessor that implements one or more of the techniques presented in this document. The apparatus 605 can include transceiver electronics 615 to send and/or receive wireless signals over one or more communication interfaces such as antenna(s) 620. The apparatus 605 can include other communication interfaces for transmitting and receiving data. Apparatus 605 can include one or more memories (not explicitly shown) configured to store information such as data and/or instructions. In some implementations, the processor electronics 610 can include at least a portion of the transceiver electronics 615. In some embodiments, at least some of the disclosed techniques, modules or functions are implemented using the apparatus 605.

It is intended that the specification, together with the drawings, be considered exemplary only, where exemplary means an example and, unless otherwise stated, does not imply an ideal or a preferred embodiment. As used herein, the use of “or” is intended to include “and/or”, unless the context clearly indicates otherwise.

Some of the embodiments described herein are described in the general context of methods or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Therefore, the computer-readable media can include a non-transitory storage media. Generally, program modules may include routines, programs, objects, components, data structures, etc. that perform particular tasks or implement particular abstract data types. Computer- or processor-executable instructions, associated data structures, and program modules represent examples of program code for executing steps of the methods disclosed herein. The particular sequence of such executable instructions or associated data structures represents examples of corresponding acts for implementing the functions described in such steps or processes.

Some of the disclosed embodiments can be implemented as devices or modules using hardware circuits, software, or combinations thereof. For example, a hardware circuit implementation can include discrete analog and/or digital components that are, for example, integrated as part of a printed circuit board. Alternatively, or additionally, the disclosed components or modules can be implemented as an Application Specific Integrated Circuit (ASIC) and/or as a Field Programmable Gate Array (FPGA) device. Some implementations may additionally or alternatively include a digital signal processor (DSP) that is a specialized microprocessor with an architecture optimized for the operational needs of digital signal processing associated with the disclosed functionalities of this application. Similarly, the various components or sub-components within each module may be implemented in software, hardware or firmware. The connectivity between the modules and/or components within the modules may be provided using any one of the connectivity methods and media that is known in the art, including, but not limited to, communications over the Internet, wired, or wireless networks using the appropriate protocols.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few implementations and examples are described and other implementations, enhancements and variations can be made based on what is described and illustrated in this disclosure.

What is claimed is:

1. A method for wireless communication, comprising:
establishing, by a network node, a first cell comprising a first channel on which the network node receives communications and a second channel on which the network node transmits communications; and
performing a bi-directional communication with a wireless device using the first cell,
wherein the first channel comprises a first frequency from a first frequency band and the second channel comprises a second frequency from a second frequency band different from the first frequency band, wherein the first frequency is designated for communications from the wireless device to the network node, and wherein the second frequency is designated for communication from the network node to the wireless device.

2. The method of claim 1, wherein the method further comprises:
establishing a second cell comprising a third channel on which the network node receives communications and a fourth channel on which the network node transmits communications; and
performing another bi-directional communication with another wireless device using the second cell, wherein the third channel comprises a third frequency from the second frequency band, wherein the fourth channel comprises a fourth frequency from the first frequency band, wherein the third frequency is designated for communications from the wireless device to the network node, and wherein the fourth frequency is designated for communication from the network node to the wireless device.

3. The method of claim 1, wherein the second channel is a supplementary channel, and wherein the secondary frequency band excludes a frequency that is designated for communications from the wireless device to the network node.

4. The method of claim 1, further comprising:
determining that a first pathloss for the first channel is different from a second pathloss for the second channel; and
signaling, to the wireless device, power control information for the first channel based on the first pathloss and the second pathloss.

5. The method of claim 4, wherein the power control information for the first channel comprises an initial power for transmissions by the wireless device.

6. The method of claim 1, further comprising:
selecting the first frequency band and the second frequency band based on a number or a geographic distribution of wireless devices in a cell.

7. The method of claim 1, further comprising:
broadcasting, to at least the wireless device, information corresponding to the first frequency and the second frequency.

8. A method of wireless communication, comprising:
performing, at a wireless device, a bi-directional communication with a network node using a cell comprising a first channel on which the wireless device transmits communications and a second channel on which the wireless device receives communications,
wherein the first channel comprises a first frequency from a first frequency band and the second channel comprises a second frequency from a second frequency band different from the first frequency band.

9. The method of claim 8, further comprising:
receiving an initial transmit power parameter for the first channel,
wherein a transmission of the bi-directional communication is performed using a power based on the initial transmit power parameter for the first channel.

10. The method of claim 8, further comprising:
receiving, from the network node prior to performing the bi-directional communication, a broadcast transmission comprising information corresponding to the first frequency and the second frequency.

11. An apparatus for wireless communication, comprising:
a processor; and
a memory with instructions thereon, wherein the instructions upon execution by the processor cause the processor to:
establish, by a network node, a first cell comprising a first channel on which the network node receives communications and a second channel on which the network node transmits communications; and
perform a bi-directional communication with a wireless device using the first cell,
wherein the first channel comprises a first frequency from a first frequency band and the second channel comprises a second frequency from a second frequency band different from the first frequency band, wherein the first frequency is designated for communications from the wireless device to the network node, and wherein the second frequency is designated for communication from the network node to the wireless device.

12. The apparatus of claim 11, wherein the instructions further cause the processor to:
establish a second cell comprising a third channel on which the network node receives communications and a fourth channel on which the network node transmits communications; and
perform another bi-directional communication with another wireless device using the second cell, wherein the third channel comprises a third frequency from the second frequency band, wherein the fourth channel comprises a fourth frequency from the first frequency band, wherein the third frequency is designated for communications from the wireless device to the network node, and wherein the fourth frequency is designated for communication from the network node to the wireless device.

13. The apparatus of claim 11, wherein the second channel is a supplementary channel, and wherein the secondary frequency band excludes a frequency that is designated for communications from the wireless device to the network node.

14. The apparatus of claim 11, wherein the instructions further cause the processor to:
determine that a first pathloss for the first channel is different from a second pathloss for the second channel; and
signal, to the wireless device, power control information for the first channel based on the first pathloss and the second pathloss.

15. The apparatus of claim 14, wherein the power control information for the first channel comprises an initial power for transmissions by the wireless device.

16. The apparatus of claim 11, wherein the instruction further cause the processor to:
select the first frequency band and the second frequency band based on a number or a geographic distribution of wireless devices in a cell.

17. The apparatus of claim 11, wherein the instruction further cause the processor to:
broadcast, to at least the wireless device, information corresponding to the first frequency and the second frequency.

18. A non-transitory computer readable storage medium having instructions stored thereupon, the instructions, when executed by a processor, causing the processor to implement a method of wireless communication, comprising:
instructions for performing, at a wireless device, a bi-directional communication with a network node using a cell comprising a first channel on which the wireless device transmits communications and a second channel on which the wireless device receives communications,
wherein the first channel comprises a first frequency from a first frequency band and the second channel comprises a second frequency from a second frequency band different from the first frequency band.

19. The storage medium of claim 18, further comprising:
instructions for receiving an initial transmit power parameter for the first channel,
wherein a transmission of the bi-directional communication is performed using a power based on the initial transmit power parameter for the first channel.

20. The storage medium of claim 18, further comprising:
instructions for receiving, from the network node prior to performing the bi-directional communication, a broadcast transmission comprising information corresponding to the first frequency and the second frequency.
